(19) United States
(12) Patent Application Publication
(10) Pub. No.: US 2002/0006214 A1
(43) Pub. Date: Jan. 17, 2002

(54) Secure signature checking system

(76) Inventor: Sven Olof Karlsson, Lund (SE)

Correspondence Address: Gerson S. Panitch, Finnegan, Henderson, Farabow, Garrett & Dunner, L.L.P., 1300 I Street, N.W., Washington, DC, 20005-3315, US

(21) Appl. No.: 09/812,899

(22) Filed: Mar. 21, 2001

Related U.S. Application Data
(60) Provisional application No. 60/207,880, filed on May 30, 2000.

(30) Foreign Application Priority Data
Mar. 21, 2000 (SE) 0000943-1

(51) Int. Cl. G06K 9/00

(52) U.S. Cl. 382/119

(57) ABSTRACT

A system for and method of analyzing a signature. The method includes receiving the signature; building a signature model based on the signature; checking a uniqueness of at least one of the signature and the signature model; and delivering a signal which indicates the uniqueness of the signature model.

### CROSS-REFERENCE TO RELATED APPLICATIONS

This application claims priority benefits based on Swedish Patent Application No. 0000943-1, Filed Mar. 21, 2000, and U.S. Provisional Application 60/207,880, filed May 30, 2000, the technical disclosures of both of which are hereby incorporated herein by reference.

### FIELD OF THE INVENTION

The present invention relates to a system for analyzing the signature of a user, the system comprising a user unit and a checking device, the user unit being arranged to record a signature which the user writes with the user unit, and to send the signature to the checking device which is arranged to receive the signature. The invention also relates to a checking device for analyzing a user's signature which is written with a user unit, the checking device being arranged to receive the signature, and a method for analyzing a signature.

### BACKGROUND OF THE INVENTION

The signature has long been used to increase security in financial and other transactions. For example, signatures are used on checks and card payments to confirm the identity of a person making or receiving a payment. Signatures can be written with a normal pen or with an electronic pen. With electronic pens, it is possible to increase the number of parameters which describe the signature. It is not only possible to calculate the same parameters as with a normally written signature such as, for example, the absolute size and slope of the letters, but it is also possible to calculate, for example, electronic pen pressure and the speed with which the signature is written. This is disclosed, for example, in an article entitled “Optimization issues in dynamic and static signatures verification in Handwriting Analyzing and Registration” (ref. No. 1998/440), IEE Third European Workshop, 1998, page 5/1-5/6, written by C. C. Allgrove and M. C. Fairhurst, the technical disclosure of which is incorporated herein by reference. That article also describes a method with which a verification database can be synthesized. In the article, a verification system is described including a verification database in which reference models for a number of signatures are stored. Since the signature of a person varies slightly every time it is written, the reference model accounts for these variations. When a reference model is synthesized, the user writes a signature a number of times and this provides a range within which the signature of the user lies. To improve the reference model, the signature or signatures which differ from the user's other written signatures can be filtered out.

### SUMMARY OF A FEW ASPECTS THE INVENTION

The invention provides a method of analyzing a signature. The method may include receiving the signature; building a signature model based on the signature; checking the uniqueness of the signature; and delivering a signal which indicates the uniqueness of the signature model.

The invention also includes a computer-readable medium containing instructions for analyzing a signature. The instructions may include: receiving the signature; building a signature model based on the signature; checking the uniqueness of the signature; and delivering a signal which indicates the uniqueness of the signature model.

In addition, the invention may provide a system for analyzing a user's signature. The system may include a user unit for receiving the signature from the user, and a checking device in communication with the user unit. The checking device may be operable to build a signature model based on the signature, check the uniqueness of the signature, and deliver a signal which indicates the uniqueness of the signature model.

Additional details of the invention will be set forth in part in the description which follows, and in part will be obvious from the description, or may be learned by practice of the invention. The objects and advantages of the invention will be realized and attained by means of the elements and combinations particularly pointed out in the appended claims.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

The invention will be described in greater detail in the text which follows, referring to the accompanying drawings.

FIG. 1 illustrates a schematic view of a system consistent with an embodiment of the present invention.

FIG. 2 illustrates a user unit consistent with an embodiment of the present invention.

FIG. 3 illustrates an example of a handwritten signature.

FIG. 4 illustrates a flow chart describing a method of analyzing a signature consistent with the present invention.

### DETAILED DESCRIPTION OF THE PREFERRED EMBODIMENTS

More specifically, the invention may provide, according to a first aspect, a system for analyzing a user's signature, the system comprising a user unit and a checking device, the user unit being arranged to record a signature when the user is writing with the user unit, and to send the signature to the checking device which is arranged to receive the signature, the checking device being further arranged to build a signature model based on the signature, and to make a check of the uniqueness of the signature model and, after the check, to deliver a signal which indicates the uniqueness of the signature model.

The invention may provide a user with the possibility of checking the uniqueness of his or her signature. A unique signature means not only that the signature is unlike other signatures but also, for example, that it contains characteristics which bring about better machine recognition of the signature. The signature is normally the user's signature, but can also be a symbol or any type of sign. An advantage of the user being able to check the uniqueness of his or her signature is that the user can obtain an indication of how good the signature is, i.e., for example, how difficult it is to forge, to mistake for another signature, or how simple it is to process in a machine-recognition program.

The user unit or part of the user unit can be constructed as a pen with which the user writes the signature and can be, for example, a digital pen. The user unit may record the signature and send a representation of the signature to the checking device.

When the signature is received by the checking device, one or more parameters can be determined. These parameters can be, for example, the length of the signature, the slope of the letters and/or the number of bends in the signature. A bend can be defined as a relatively large change in the direction of the signature. The parameters can then be compared with predetermined minimum levels within which they should lie for the signature to be considered to meet certain uniqueness requirements. In a very simple case, the signature model may consist of a signature and the above-mentioned check can be the uniqueness check itself. In a very simple example of a uniqueness check, the check may be performed on only one parameter, for example, the number of bends in the signature. If, in this case, the signature only consists of a line, the number of bends is zero. If, for example, the limit level for the number of bends is determined to be greater than or equal to 10 for the signature to be determined to be unique, the checking device will determine that the signature is not unique. Apart from comparing the parameter with a predetermined limit level, it can also be compared with one or more parameters of signatures which were stored earlier. Taking the former case where the parameter is the number of bends, it could be determined that, for a signature to be considered as unique, it must differ by two steps in the number of bends from signatures stored earlier.

The checking unit can be arranged in, for example, a verification system in which several signature models are stored. The checking unit may then be arranged to check the uniqueness of the received signature model by comparing it with all or a large group of stored signature models. The signature model can be determined to be unique if it distinguishes to a certain degree from all the stored signature models.

The comparison may be carried out partly with a predetermined limit level and partly with signatures stored earlier. A large number of different parameters may be used for making the check of the uniqueness of the signature. The signature model can be synthesized from a number of received signatures from the same user, but can also be made up of only the received signature, which was the simple case mentioned above. If the signature model is composed of a number of signatures, the above-mentioned minimum requirements check can be carried out for each signature, which then synthesizes the signature model. If the minimum requirements check is carried out, the signature model may be composed of signatures which at least meet certain criteria. The checking device may then carry out a check on how unique the signature model is. To carry out the check and evaluate the different parameters, different classification methods can be used. Normally, a classifier which can be, for example, a neural network, is used in these methods. A classifier can be “trained” by feeding in parameters of a signature and comparing the response value that comes out with the required result. If the response value is not the one required, the classifier may be adjusted, the parameters fed in again, and the response value compared with the one required. This is continued until the required result is obtained. When a uniqueness check is to be carried out on a signature, which does not need to be stored in the neural network, its parameters can be fed into the classifier. The response value output from the classifier can be a measure of uniqueness.

The classifier can also provide an indication of how close a signature is to a signature model stored earlier.

If the signature input comprises more than one signature, the classification may normally be done after each received signature and the signature model can be synthesized in this manner.

When the check of the uniqueness of the signature input is completed, the checking device may send a signal to the user unit in order to inform the user about how unique his signature is. If the uniqueness is not adequate, the checking device may send along information about what can be changed in the signature to make it unique. The signal may also be only an enabling signal which indicates that the signature is unique, or a signal which only indicates that the signature is not sufficiently unique.

In another embodiment of the system, the signature model is the input signature.

Sometimes it may be desirable to get a quick check of the uniqueness of the signature and the user may then only write his signature once. The signature model is then the input signature, and the checking device is then arranged to check the uniqueness of this single signature.

In one embodiment of the system, the checking device may be arranged to synthesize the signature model from a number of signatures received from the same user.

The signature model may be advantageously synthesized from a number of signatures written by the same user. The advantage of this signature model is that it takes into account variations in the signature of the same user. A user often has small variations between different writings of the signature. The signature model can be improved further by eliminating, for example, the signature which differs the most from the other ones.

In another embodiment of the system, the checking device may be arranged to calculate, in the check of the uniqueness of the signature model, at least one parameter which is characteristic of the signature model and to make a check of the parameter.

There are many parameters which may be interesting to examine in the signature model for checking its uniqueness. As mentioned above, one parameter may be enough for making a uniqueness check, but a plurality of parameters may be used since the uniqueness check of the signature becomes more secure. Access to a large number of parameters provides better classification. The uniqueness check does not need to be made directly on the parameter, but the parameter can be fed directly to a classifier. The classifier may provide a response value which provides a measure of uniqueness and on which the uniqueness check can be carried out.

A parameter which can be used for the uniqueness check is, for example, the extent of the signature. The extent can be calculated, for example, as a height/length ratio or an absolute length. Other parameters can be, for example, the number of bends, the derivative of movement in the x-direction and y-direction, the absolute size of the signature, crossings, curves, line ends and the pressure with which the signature is written. Further parameters can be the slope of letters and words.

In one embodiment of the system according to the invention, the checking device may be arranged to check, in the check of said at least one parameter, that said at least one parameter is above a predetermined uniqueness limit level.

The uniqueness limit level may be set at a level at which, if said at least one parameter of the signature model is below this level, the signature model is determined not to be unique. If, on the other hand, it exceeds or is at this level, the signature is considered to be unique. Certainly, this level can be defined in such a manner that, if the level is below the predetermined uniqueness limit level, the signature is determined to be unique. It can be defined in the system how the checking device processes the comparison of said at least one parameter with the uniqueness limit level. An advantage of using this uniqueness limit level is that it is possible to obtain an indication of how unique the user's signature is on the basis of how much the signature model differs from the uniqueness limit level.

The signal from the checking device to the user unit can contain information on whether the signature model is over, under, or on the limit of the uniqueness limit level. The signal can also contain information about how much it deviates from the uniqueness limit level. The advantage of this is that the user gains information on how secure his or her signature is and, based on this, the user may obtain, for example, an indication of what the signature can be used for. If the signature has a high degree of uniqueness, the user may be able to use it, for example, in a payment system.

The uniqueness limit level of the checking device can be adjusted depending on the application in which the user's signature is intended to be used. The system can be arranged in such a manner that the user unit sends information about the application together with the signature to the checking device. The checking device may then use the uniqueness limit level belonging to this application. If a classifier is used, the uniqueness limit level can be a response limit level. If the response limit level from the classifier is increased, the security level can be increased. The output value from the classifier can be compared with the response limit level for determining if the signature is unique.

In another embodiment of the system according to the invention, the signal may comprise information about what the user has to change in the signature for the parameter to end up above the uniqueness limit level.

The advantage of the user obtaining information about what to change in the signature to render it unique is that the user can obtain a unique signature in a quick and simple manner. The user does not need to randomly change different parts of the signature until it is determined to be unique, but can obtain direct information on what to change.

In one embodiment of the system, the checking device may also be arranged to classify the signature. If the signature model is to comprise more than one signature, each signature may be classified to synthesize the signature model.

To facilitate the classification of the signature, a number of parameters may be used. The advantage of classifying is that it becomes quicker to check the uniqueness of the signature. As mentioned above, there are different methods for carrying out a classification.

In yet another embodiment of the system, the checking device may be arranged to compare, in the check of the uniqueness of the signature model, the signature model with other signatures.

In order for the signature to be unique in relation to signatures stored earlier, the signature model is compared with signature models stored earlier so that the stored signature models are not too similar to each other. The signal from the checking device to the user unit can provide information for the user about what the user needs to change in his signature so that it is not too similar to an earlier signature written by another person. The degree to which two written signatures should differ will depend on the application of the signature. This comparison may be carried out advantageously in combination with the check that the signature model is above a predetermined uniqueness limit level.

In one embodiment of the system, the signature may be recorded as a sequence of coordinates which describe the displacement of the user unit when the user writes his signature with the user unit.

By describing the signature as a sequence of coordinates, it is possible to calculate different parameters of the signature in a simple manner.

In another embodiment, the system may include a base which is provided with a position-coding pattern which enables the coordinates to be calculated and from which the user unit is arranged to record the sequence of coordinates.

The user unit may record the pattern and suitably calculate its corresponding pairs of coordinates. The pairs of coordinates can be stored in a memory in the user unit. The user unit can also be arranged to analyze stored pairs of coordinates and to convert these to a train of polygons, which constitute a description of how the pen has been displaced over a surface which is provided with the position-coding pattern, the displacement being the user's signature. The train of polygons can then be transferred to the checking device for a uniqueness check. The time at which different pairs of coordinates were recorded can also be recorded to obtain an additional parameter.

In one embodiment of the system, the user unit may include an optical sensor and image-processing means for recording the signature.

The optical sensor may capture images and image-processing means process the images, which may include determination of the coordinates from the content of the images, in which case the content can be the above-mentioned position-coding pattern.

In one embodiment of the system, the checking device may be arranged in a verification database. The checking device is advantageously arranged in a verification database in which a plurality of different signatures can be stored in the form of signature models. If the signature model is already stored in the memory, the verification database can also confirm the correctness of the signature. This can be done, for example, by the user unit sending along a user identity to the verification database. The verification database then knows with which signature a comparison is to be made. The signal which is delivered to the user unit can then inform the user about how similar the signature is to the stored one. Perhaps, the user's signature has changed.

According to another aspect, the invention may also relate to a checking device for analyzing a user's signature which is written with a user unit, the checking device being arranged to receive the signature, the checking device being further arranged to build a signature model based on the signature, to make a check of the uniqueness of the signature model and to deliver a signal, which indicates the uniqueness of the signature model.

According to another aspect, the invention may include a method for analyzing a signature comprising the steps of recording a signature with the aid of a user unit, sending on a representation of the signature to a checking device, building up a signature model in the checking device, making a check of the uniqueness of the signature model in the checking device and, after the check, delivering a signal, which indicates the uniqueness of the signature model.

According to another aspect, the invention may include a method for analyzing a user's signature, which is written by a user unit. This method may include receiving the signature, building a signature model based on the signature, making a check of the uniqueness of the signature model, and delivering a signal, which indicates the uniqueness of the signature model.

The check of the uniqueness can be made by comparing the received signature model with already stored signature models. These signature models can be stored and used in a verification system, which verify users by their signatures. The received signature model must distinguish from all stored signatures to be considered unique.

The invention may also include a computer program product directly loadable into the internal memory of a digital computer, comprising software code portions for performing the steps of above-mentioned method when the product is run on a computer.

The features discussed with respect to the system also apply in suitable parts to the checking device and the methods.

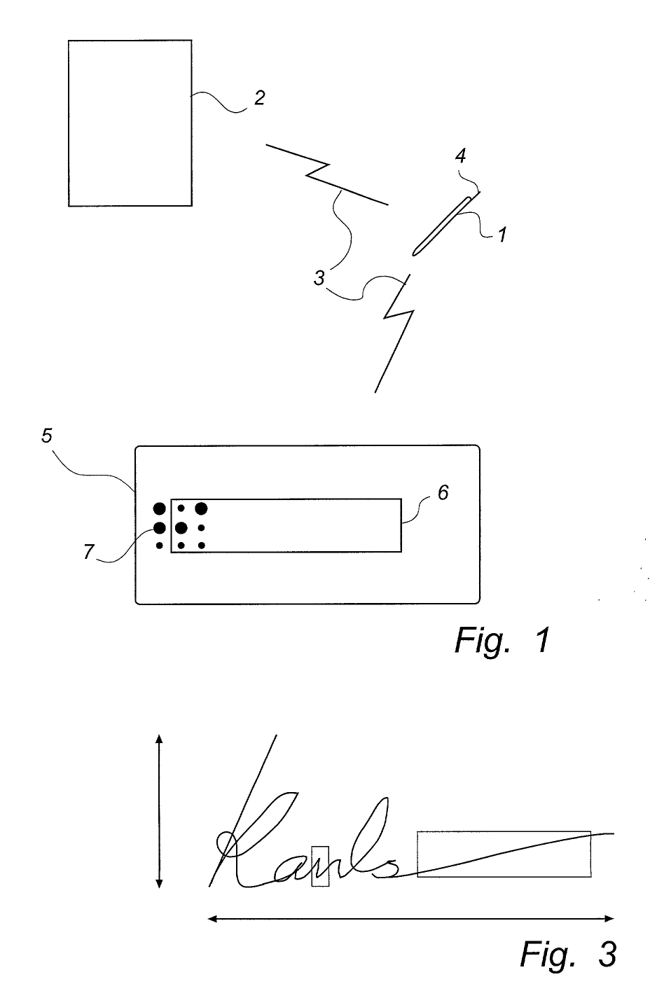

FIG. 1 shows an exemplary embodiment of the system according to the invention. The system may include a number of user units 1 and a checking device integrated with a verification database 2. For the sake of simplicity, FIG. 1 only shows one user unit. The verification database 2 and the user unit 1 may communicate via a computer network 3. The user unit 1 may be equipped with a network access unit 4 which, in this example, can communicate wired or wirelessly with the verification database 2. The network access unit is in this example integrated with the user unit but, as an alternative, can be a mobile telephone, a computer or some other suitable unit which has an interface to a network, for example, the Internet or a local company network.

Writing Base

FIG. 1 shows an example of a writing base 5 which is like a normal magnetic or credit card in size and material. The writing base 5 may have a writing field 6 which may have a size of 10 mm×200 mm and can be provided with coordinates which can be read by the digital pen 1. The coordinates can be specified in explicit or coded form. In this example, the writing base 5 is provided with a position-coding pattern 7. The pattern 7 is shown schematically as a number of dots on a part of the writing base 5.

The writing field 6 may be intended for handwritten information which, in this case, is the user's signature. The writing base 5 can be made of such material that the signature can be erased after it has been written. As an alternative, the combination of pen and writing base can be such that no dye or other marking is deposited on the writing base when the user writes the signature.

The position-coding pattern 7 can be of such a type as is shown in U.S. Pat. No. 5,852,434 (the technical disclosure of which is incorporated herein by reference), where each position is coded by a specific symbol.

However, the position-coding pattern 7 may also be of the type shown in Applicants' above-mentioned applications WO 00/73983, PCT/SE00/01895 and WO 01/16691 (each of which is incorporated herein by reference), where each position is coded by a plurality of symbols and each symbol contributes to the coding of a plurality of positions. The position-coding pattern 7 is built up by a small number of types of symbols. One example is shown in WO 00/73983, where a relatively large dot represents a “one” and a smaller dot represents a “zero”. Another example is shown in PCT/SE00/01895 and WO 01/16691, where four different displacements of a dot in relation to a raster point code four different values. Moreover, reference is made to WO 01/16691, also incorporated herein by reference.

User Unit

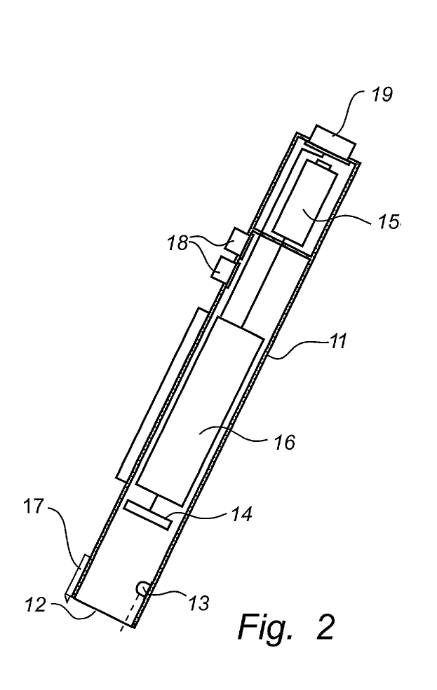

FIG. 2 shows an example of a user unit which, in this example, consists of a digital pen 1. It may include a casing 11 which may have the approximate shape of a pen. In a short side of the casing there may be an opening 12. The short side may be configured to bear against or be held at a short distance from the surface on which the position determination is to be carried out.

The casing may accommodate an optical part, an electronic part and a power supply.

The optical part may include at least one light-emitting diode 13 for illuminating the surface which is to be imaged and a light-sensitive area sensor 14, for example a CCD or CMOS sensor, for recording a two-dimensional image. The arrangement may also contain a lens system.

The power supply for the user unit may be obtained from a power source, such as battery 15, which may be mounted in a separate compartment in the casing.

The electronic part may include a processor 16 programmed for reading an image from the sensor 14, identifying symbols in the image, determining which two coordinates are coded by the symbols, and storing these coordinates in its memory. The processor 16 may also be programmed for analyzing stored pairs of coordinates and converting them to a train of polygons which constitutes a description of how the pen has been displaced over a surface which is provided with the position-coding pattern, which displacement can be, for example, the user's signature. Finally, the processor may be programmed to generate a message which contains the train of polygons and to send this information to the verification database 2 via a transceiver 19 and the network access unit 4.

The digital pen 1 may also include a pen point 17, with the aid of which the user can write normal dye-based writing which, at the same time, is recorded by the pen 1 with the aid of the position-coding pattern. The pen point 17 may be retractable and extendable so that the user can control whether it is to be used or not. The term “pen” is used herein to generally refer to any marking implement.

The digital pen 1 may also include buttons 18, with the aid of which the unit may be activated and controlled. It also may have a transceiver 19 for wired or wireless communication, e.g. by means of IR light or radiowaves (such as, for example, BLUETOOTH), with external units.

Check of the Uniqueness of a Signature

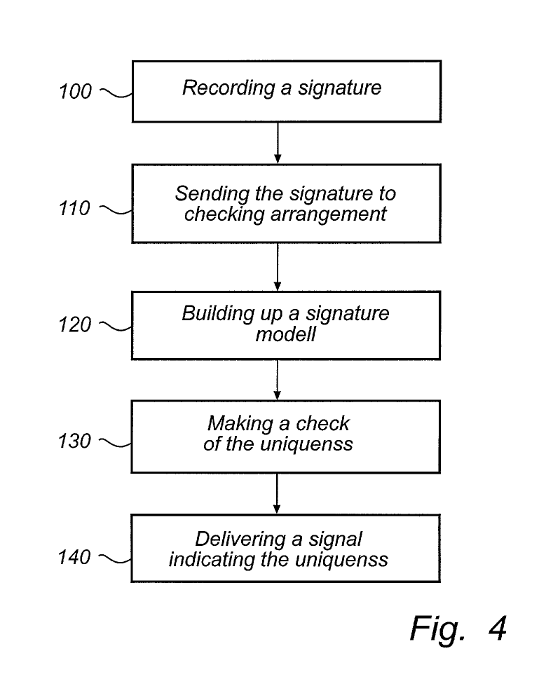

FIG. 1 shows an embodiment of the invention in which the user unit is a digital pen 1 and the checking device is arranged in a verification database 2. FIG. 4 illustrates an exemplary flow chart for the method. The verification database 2 can serve a plurality of digital pens 1. The digital pen 1 may be arranged to transfer information generated by the user to the verification database 2. In this case, the information may be transferred via a network access unit 4, which is integrated with the digital pen 1. The verification database 2 may be implemented in a computer which is configured with one or more processors, memories of different types, peripheral units and with software for carrying out the functions described here. It also may store information in a memory for managing these functions.

In the memory of the verification database 2, signature models written earlier and different uniqueness limit levels may be stored. A signature model received in the verification database may be compared with the uniqueness limit levels for checking the uniqueness of the signature model. The uniqueness limit levels can be linked, for example, to different applications which make different demands on security. It may be possible for a user to select on the user unit the application and/or the security level at which the signature is to lie. This information can be transferred to the verification database together with the signature. The verification database 2 can then use the limit level which is associated with the specified application.

When a user wishes to add her signature to a verification database, she may first investigate if her signature is unique. She, therefore, may write her signature with the digital pen 1 on a writing base 5. The pen 1 may record the signature electronically as a sequence of coordinates (step 100). It also may record the time instant for each coordinate. Thus, it may be possible to calculate the speed and acceleration by taking the derivative of the position coordinate over time. Moreover, it is possible to calculate the tilt of the pen or angle and rotation to the base. It is also possible to equip the digital pen 1 with a pressure sensor, which senses the pressure with which the signature is written. The pressure can be determined at different times. The sequence of coordinates, times, and other data at which the pen passes these coordinates may be sent to the verification database 2 via the network access unit 4 and over the computer network 3 (step 110). The user may write her signature one or more times and the user unit transfers this information. The signature may be written a number of times, since there are certain variations between different writings of the signature, and to compensate for these, a signature model may be built up (step 120) which sets up frames for how much the signature can vary in order to be considered as belonging to the same user. The verification database receives and classifies each signature. When each signature is received, a minimum requirements check can be carried out, that confirms that the signature fulfills at least some of the requirements of the uniqueness. For example, the length of the signature can be checked and, if it is below a predetermined minimum level, a signal can be sent to the user unit which tells the user that the signature cannot be accepted because it is too long or too short and, thus, insufficiently unique. The signal can also contain information about why the signature cannot be accepted. Each signature is classified on the basis, for example, of the extent of the signature. The extent can be calculated, for example, as a height/length ratio or as an absolute length. Other classification parameters can be the number of bends, the derivative of the movement in the x-direction and y-direction, crossings in the signature, curves and line ends. Other parameters can be the slope of letters and words. The determination and evaluation of the different parameters by the verification database can be done, for example, with the aid of statistical methods, frequency analysis, neural networks or some other classification method such as, for example, Nearest Neighbor. Normally, a classifier may be used in these methods. A classifier can be “trained” by feeding in parameters and comparing the result obtained with the result required. If the result is not the one required, the classifier may be adjusted, the parameters fed in again, and the result compared with that required. This may be continued until the required result is obtained. The verification database 2 may check 130 that the signature model is above an application-dependent uniqueness limit level. The signature model can also be compared with signature models stored earlier so that the signature written is not too similar to an existing signature. Depending on the application, the signature models may differ to a predetermined degree.

After the check, the verification database 2 may deliver 140 a signal to the pen 1 which signal can comprise information that the signature is sufficiently unique or alternatively that it is not sufficiently unique. If the signature is not sufficiently unique, the signal can also include information about what the user can change in his signature. If the signature, for example, only consists of a line, which means that the number of bends is zero, and the limit level for the number of bends is determined to be greater than or equal to 10 for the signature to be determined to be unique, the checking device will determine that the signature is not unique. The signal to the user unit can then inform the user that he or she must increase the number of bends in the signature. The check signal may as well be delivered to other receivers, such as a mobile telephone with a display, a PDA or a personal computer.

The information about which changes can be made can be presented by the areas in the signature which need to be changed being encircled, see FIG. 3. This information can be supplemented with a text message which tells the user which changes are required in the encircled areas.

Although a special embodiment of the invention has been described above, it is obvious to a person skilled in the art that many alternatives, modifications and variations are possible to be carried out in the light of the above description.

Concurrently filed with the application for this patent are applications entitled Systems and Methods for Information Storage based on Swedish Application No. 0000947-2, filed Mar. 21, 2000, and U.S. Provisional Application No. 60/207,839, filed May 30, 2000; Secured Access Using a Coordinate System based on Swedish Application No. 0000942-3, filed Mar. 21, 2000, and U.S. Provisional Application No. 60/207,850 filed on May 30, 2000; System and Method for Printing by Using a Position Coding Pattern based on Swedish Application No. 0001245-0, filed on Apr. 5, 2000, and U.S. Provisional Application No. 60/210,651, filed on Jun. 9, 2000; Apparatus and Methods Relating to Image Coding based on Swedish Application No. 0000950-6, filed on Mar. 21, 2000, and U.S. Provisional Application No. 60/207,838, filed on May 30, 2000; Apparatus and Methods for Determining Spatial Orientation based on Swedish Application No. 0000951-4, filed on Mar. 21, 2000, and U.S. Provisional Application No. 60/207,844, filed on May 30, 2000; System and Method for Determining Positional Information based on Swedish Application No. 0000949-8, filed Mar. 21, 2000, and U.S. Provisional Application No. 60/207,885, filed on May 30, 2000; Method and System for Transferring and Displaying Graphical Objects based on Swedish Application No. 0000941-5, filed Mar. 21, 2000, and U.S. Provisional Application No. 60/208,165, filed May 31, 2000; Online Graphical Message Service based on Swedish Application No. 0000944-9, filed Mar. 21, 2000, and U.S. Provisional Application No. 60/207,881, filed May 30, 2000; Method and System for Digitizing Freehand Graphics With User-Selected Properties based on Swedish Application No. 0000945-6, filed Mar. 21, 2000, U.S. Provisional Application No. 60/207,882, filed May 30, 2000; Data Form Having a Position-Coding Pattern Detectable by an Optical Sensor based on Swedish Application No. 0001236-9, filed Apr. 5, 2000, and U.S. Provisional Application No. 60/208,167, filed May 31, 2000; Method and Apparatus for Managing Valuable Documents based on Swedish Application No. 0001252-6, filed Apr. 5, 2000, and U.S. Provisional Application No. 60/210,653 filed Jun. 9, 2000; Method and Apparatus for Information Management based on Swedish Application No. 0001253-4 filed Apr. 5, 2000, and U.S. Provisional Application No. 60/210,652, filed Jun. 9, 2000; Device and Method for Communication based on Swedish Application No. 0000940-7, filed Mar. 21, 2000, and U.S. Provisional Application No. 60/208,166, filed May 31, 2000; Information-Related Devices and Methods based on Swedish Application No. 0001235-1, filed Apr. 5, 2000, and U.S. Provisional Application No. 60/210,647, filed Jun. 9, 2000; Processing of Documents based on Swedish Application No. 0000954-8, filed Mar. 21, 2000, and U.S. Provisional Application No. 60/207,849, filed May 30, 2000; Secure Signature Checking System based on Swedish Application No. 0000943-1, filed Mar. 21, 2000, and U.S. Provisional Application No. 60/207,880, filed May 30, 2000; Identification of Virtual Raster Pattern, based on Swedish Application No. 0001235-1, filed Apr. 5, 2000, and U.S. Provisional Application No. 60/210,647, filed Jun. 9, 2000, and Swedish Application No. 0004132-7, filed Nov. 10, 2000, and U.S. Provisional Application No. ______, filed Jan. 12, 2001; and a new U.S. Provisional Application entitled Communications Services Methods and Systems.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

In the foregoing Description of Preferred Embodiments, various features of the invention are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Preferred Embodiments, with each claim standing on its own as a separate preferred embodiment of the invention.

What is claimed is:

1. A method of analyzing a signature, comprising:
receiving the signature;
building a signature model based on the signature;
checking a uniqueness of at least one of the signature and the signature model; and
delivering a signal which indicates the uniqueness of the signature model.

2. The method of claim 1, wherein receiving the signature further comprises receiving at least one pair of coordinates which constitutes a description of the signature.

3. The method of claim 1, wherein receiving the signature further comprises receiving a train of polygons which constitutes a description of the signature.

4. The method of claim 2, wherein receiving the signature further comprises receiving a time code with each respective pair of coordinates.

5. The method of claim 2, wherein receiving the signature further comprises receiving a pressure value with each respective pair of coordinates.

6. The method of claim 1, wherein building a signature model further comprises classifying the signature.

7. The method of claim 1, wherein building a signature model further comprises building the signature model from a plurality of user signatures.

8. The method of claim 1, wherein checking a uniqueness further comprises checking at least one parameter of the signature.

9. The method of claim 8, wherein the parameter is a length of the signature.

10. The method of claim 8, wherein the parameter is a slope of letters of the signature.

11. The method of claim 8, wherein the parameter is a number of bends of the signature.

12. The method of claim 8, wherein the parameter is a height/length ratio of the signature.

13. The method of claim 8, wherein the parameter is a derivative of a movement of the signature.

14. The method of claim 8, wherein the parameter is a size of the signature.

15. The method of claim 8, wherein the parameter is a pressure of the signature.

16. The method of claim 8, further comprising comparing the parameter to a predetermined uniqueness limit.

17. The method of claim 1, wherein checking a uniqueness further comprises checking the signature against a database of existing signature models.

18. The method of claim 1, wherein delivering a signal which indicates the uniqueness of the signature model further comprises delivering a signal indicative of whether the signature is below a uniqueness limit.

19. The method of claim 1, wherein delivering a signal which indicates the uniqueness of the signature model further comprises delivering a signal indicative of whether the signature is above a uniqueness limit.

20. The method of claim 1, wherein delivering a signal which indicates the uniqueness of the signature model further comprises delivering a signal indicative of how much the signature deviates from a uniqueness limit.

21. The method of claim 1, wherein delivering a signal which indicates the uniqueness of the signature model further comprises delivering a signal indicative of what to change about the signature in order to render the signature unique.

22. A computer-readable medium containing instructions for analyzing a signature, the instructions comprising:
receiving the signature;
building a signature model based on the signature;
checking a uniqueness of at least one of the signature and the signature model; and
delivering a signal which indicates the uniqueness of the signature model.

23. The computer-readable medium of claim 22, wherein the instruction for receiving the signature further comprises an instruction for receiving at least one pair of coordinates which constitutes a description of the signature.

24. The computer-readable medium of claim 22, wherein the instruction for receiving the signature further comprises an instruction for receiving a train of polygons which constitutes a description of the signature.

25. The computer-readable medium of claim 23, wherein the instruction for receiving the signature further comprises an instruction for receiving a time code with each respective pair of coordinates.

26. The computer-readable medium of claim 23, wherein the instruction for receiving the signature further comprises an instruction for receiving a pressure value with each respective pair of coordinates.

27. The computer-readable medium of claim 22, wherein the instruction for building a signature model further comprises an instruction for classifying the signature.

28. The computer-readable medium of claim 22, wherein the instruction for building a signature model further comprises an instruction for building the signature model from a plurality of user signatures.

29. The computer-readable medium of claim 22, wherein the instruction for checking a uniqueness further comprises an instruction for checking at least one parameter of the signature.

30. The computer-readable medium of claim 22, wherein the instruction for checking a uniqueness further comprises an instruction for checking the signature against a database of existing signature models.

31. The computer-readable medium of claim 22, wherein the instruction for delivering a signal which indicates the uniqueness of the signature model further comprises an instruction for delivering a signal indicative of whether the signature is below a uniqueness limit.

32. The computer-readable medium of claim 22, wherein the instruction for delivering a signal which indicates the uniqueness of the signature model further comprises an instruction for delivering a signal indicative of whether the signature is above a uniqueness limit.

33. The computer-readable medium of claim 22, wherein the instruction for delivering a signal which indicates the uniqueness of the signature model further comprises an instruction for delivering a signal indicative of how much the signature deviates from a uniqueness limit.

34. The computer-readable medium of claim 22, wherein the instruction for delivering a signal which indicates the uniqueness of the signature model further comprises an instruction for delivering a signal indicative of what to change about the signature in order to render the signature unique.

35. A system for analyzing a user's signature, comprising:
a user unit for receiving the signature from the user; and
a checking device, in communication with the user unit, for building a signature model based on the signature, checking a uniqueness of at least one of the signature and the signature model, and deliver a signal which indicates the uniqueness of the signature model.

36. The system of claim 35, wherein the user unit is further operative to generate at least one pair of coordinates which constitute a description of the signature.

37. The system of claim 35, wherein the user unit is further operative to generate a train of polygons which constitutes a description of the signature.

38. The system of claim 35, further comprising a base provided with a position coding pattern and wherein the user unit is further operative to calculate at least a pair of coordinates generated from reading the coding pattern.

39. The system of claim 35 wherein the user unit further comprises and optical sensor and image processor for receiving and processing the signature.

40. The system of claim 36, wherein the user unit is further operative to generate a time code associated with each respective pair of coordinates.

41. The system of claim 36, wherein the user unit is further operative to receive a pressure value to be associated with each respective pair of coordinates.

42. The system of claim 35, wherein the checking device is operative to classify the signature.

43. The system of claim 35, wherein the checking device is further operative to build the signature model from a plurality of user signature.

44. The system of claim 35, wherein the checking device is further operative to check at least one parameter of the signature.

45. The system of claim 35, wherein the checking device is further operative to check the signature against a database of existing signature models.

46. The system of claim 35, wherein the checking device is further operative to deliver a signal indicative of whether the signature is below a uniqueness limit.

47. The system of claim 35, wherein the checking device is further operative to deliver a signal indicative of whether the signature is above a uniqueness limit.

48. The system of claim 35, wherein the checking device is further operative to deliver a signal indicative of how much the signature differs from a uniqueness limit.

49. The system of claim 35, wherein the checking device is further operative to deliver a signal indicative of what to change about the signature in order to render the signature unique.
